(19) United States
(12) Patent Application Publication
(10) Pub. No.: US 2003/0097918 A1
(43) Pub. Date: May 29, 2003

(54) Device for cutting paper webs

(76) Inventors: Thomas Hendle, Wurzburg (DE); Johannes Georg Schaede, Wurzburg (DE); Anton Weis, Lorsch (DE)

Correspondence Address: Douglas R Hanscom, Jones Tullar & Cooper, Eads Station, PO Box 2266, Arlington, VA, 22202, US

(21) Appl. No.: 10/239,874

(22) PCT Filed: Apr. 2, 2001
(86) PCT No.: PCT/DE01/01285

(30) Foreign Application Priority Data
Apr. 6, 2000 (DE) 100172881

(51) Int. Cl. B26D 7/06

(52) U.S. Cl. 83/98; 83/436.2

(57) ABSTRACT

The invention relates to a device for cutting paper webs (01) for forming several partial webs. The inventive device is arranged between an output of a printing machine and the input of a folder for folding the cut partial webs. Said device comprises a water jet cutting appliance (10).

The present invention relates to a device for cutting paper webs in accordance with the preambles of claims 1, 2, 3 or 4.

Such devices are employed, for example, in high-speed web-fed printing presses for printing illustrated and other printed products with large numbers of copies in order to divide a wide web, on which respectively several pages of the printed products have been printed side-by-side, into partial webs, each of which corresponding to a single page. The partial webs separated in this way are bundled and fed to the folding apparatus.

A device for cutting a moving web by means of a water jet is known from U.S. Pat. No. 4,266,112, but the questions of what material the web can be made is left open. The suitability of this device for cutting a paper web cannot be determined from this publication because one skilled in the art, knowing that paper has the tendency to absorb water and to swell, must assume that this will also occur if this device is used for cutting paper. Further than that, because of the low web speed of less than 1 m/s, this device is not suitable for being employed in connection with printing presses.

A device for a shaping processing of paper in a printing press is known from U.S. Pat. No. 5,797,320, which uses a water jet for cutting out or perforating designs on a printed sheet.

The structure of a jet for generating a high-pressure water jet for cutting materials is known from U.S. Pat. No. 5,730,358.

A device for trimming the edges of paper webs with the aid of a water jet is known from WO 97/11814 A1. This device is employed in the course of paper production. In this case it must be assumed that the paper to be trimmed contains residual moisture, so that moisture possibly picked up from the cutting jet is not noted in an interfering manner. No great demands are being made on the accuracy of cutting, in particular no accurate register is required, because the paper to be cut has not yet been imprinted.

DE 91 03 749 U1 discloses a device for cutting paper webs by means of a water jet cutting device.

Technische Rundschau [Technical Magazine], No. 18, Aug. 5, 1973 pp. 25, 27, 29, 31 describes cutting parameters for various materials.

The object of the invention is based on providing a device for cutting paper webs.

In accordance with the invention, this object is attained by means of the characteristics of claims 1, 2, 3 or 4.

The advantages which can be obtained by means of the invention rest in particular in that it is possible to arrange such a device in a space-saving manner at any arbitrary straight section of the path of the paper web, wherein in the close vicinity of the paper web it requires only such sufficient installation length as corresponds to the dimensions of the jet nozzles of the cutting device.

In contrast to the device of the invention, known cutting devices for use in printing presses include rotating so-called upper and lower cutters, between which the paper web is passed. One of these patterns simultaneously represents a deflection roller for the paper web. In the course of operating these cutters it is necessary to make absolutely sure that their circumferential speed corresponds to the running speed of the paper web to be cut, so that they do not exert braking or acceleration forces on the latter which, at the high web speeds of modern printing presses, can easily result in tearing of the paper web. Regular maintenance of these cutters is required in order to assure that the paper web is actually cleanly cut at all times and is not torn by dull or badly aligned blades. Therefore the blades must be accessible to the maintenance personnel, and they must be replaceable. It is therefore necessary to provide access to the place where they are installed, which has the result that the processing section consisting of printing press, device for cutting, and folding apparatus requires considerable space.

A further advantage is that the device in accordance with the invention requires little maintenance in comparison with traditional cutter arrangements.

A further advantage is that dust which might possibly be created in the course of cutting the paper is substantially carried along by the water jet, so that it—different from a cutting device consisting of an upper and lower cutter—substantially occurs only on one side of the paper web and for this reason alone can be more easily caught. An aspiration of the dust active in the immediate vicinity of the paper web is no longer required. The suction hoods, which up to now had been used for aspirating the dust and which extend over the entire width of the web at the respective locations of the cutters and increase the space requirements of the cutting device and make maintenance of the cutter additionally more difficult, are no longer required by the device in accordance with the invention.

It generally applies that the distance between the cutting jet and the paper web preferably corresponds to three to ten times of the sonic running time transversely in respect to the jet diameter. It is presumed that the high-speed jet generated by the nozzle passes through three phases on its path, a first one, in which it forms a coherent jet, a second, in which the coherent jet disintegrates as a result of coarse drops, and a third phase, in which the coarse drops again disintegrate and form fine droplets. In the first phase the jet is well suited for cutting homogeneous media, in the second, in which the individual drops exert an intermittent force on the material to be cut, the jet is particularly suited for cutting media having an interior structure, such as grainy mineral materials, or stacks of paper with a layer structure.

While the disintegration into fine droplets probably is the result of the slowing down of the jet by air, the transition of the jet from the first into the second phase is a result of its surface tension. From the point of view of surface tension, or surface energy, a fine jet of constant diameter represents an unstable equilibrium. Minimal deviations of the diameter tend to grow, so that the jet is constricted and disintegrates into individual drops. The velocity with which the constriction takes place is necessarily proportional to the velocity with which pressure effects are propagated in the jet, i.e. to the speed of sound in the jet. Cutting experiments have shown that the transition from the first to the second phase must take place at a distance from the nozzle corresponding to three to ten times the sonic running time transversely in respect to the jet, i.e. 3·c ·d<v·10·c·d (c=speed of sound in water, d=jet diameter, v=jet velocity, D1=distance from the jet to the paper web).

Too short work distances, in particular of less than three times the sonic running time, are less preferred. It is presumed that the reason for this lies in the velocity distribution of the water transversely to the jet direction. As long as the water moves through the nozzle, the flow velocity in the center of the nozzle bore is considerably greater than at the edge, where the water is slowed down because of friction at the walls of the bore. This velocity distribution is initially maintained, even when friction ceases when the jet exits from the bore, only after a certain minimum path is the velocity distribution in the jet homogenized to the extent that the edge areas of the jet also provide a dependable total cutting effect.

A collecting receptacle for the cutting jet is arranged on an opposite side of the web at a distance of preferably 5 to 15 mm from the web. On the one hand, such a distance is short enough to dependably collect the jet after passing through the web and, on the other hand, sufficiently large to prevent the web from being pushed against the collecting receptacle in case of possible fluctuations of the tension of the web.

The collecting receptacle should be constructed in such a way that, on the one hand, it dependably slows the cutting jet down, but at the same time prevents water spray from exiting the collecting receptacle in the direction toward the web. It should moreover be prevented that the jet still performs its cutting effect in the collecting receptacle. To this end it is provided that the collecting receptacle has at least one deflecting surface, arranged obliquely to the jet direction, for slowing the jet down. With such an oblique arrangement, only the velocity component of the jet which extends vertically in relation to the deflecting surface can exert a cutting effect. This component is proportional to the cosine of the angle which the jet forms with the normal surface extension of the deflecting surface.

A further step which contributes to the limitation of the cutting effect lies in selecting the distance between the jet and the deflecting surface so that the jet arrives only in its third phase at the deflecting surface.

In accordance with a preferred embodiment of the invention, the cutting device is comprised of several jets arranged in a row for the simultaneous cutting of a web into a large number of partial webs. In this case it is practical if the collecting receptacle extends along the row for collecting the jets from all the nozzles.

To dependably prevent the exit of spray from the collecting receptacle and, if required, to draw off water which was atomized during cutting, it is preferred that the collecting receptacle can be charged with an underpressure.

The device can also be used for cutting of webs consisting of several layers of paper placed on top of each other. In such a case the distance between the jet and the web would rather be selected to lie in the upper range of the spacing intervals mentioned above, in order to assure that the jet impinges in its second phase on the web.

An exemplary embodiment of the invention is represented in the drawings and will be described in greater detail in what follows.

Shown are in:

FIG. 1, a device in accordance with the invention in a greatly schematized sectional view,

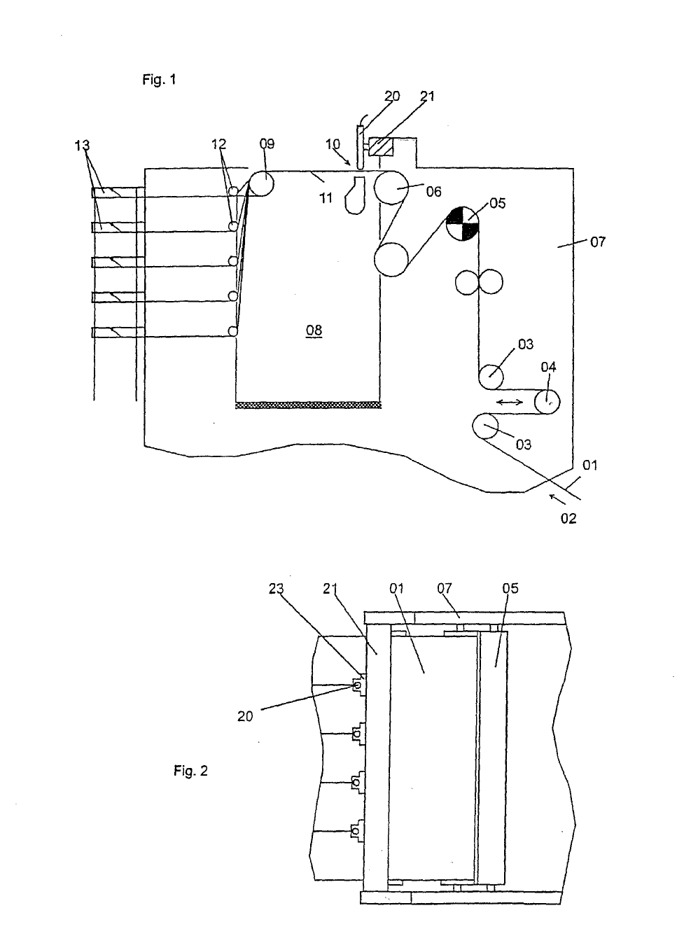

FIG. 2, a view from above on a portion of the device in FIG. 1,

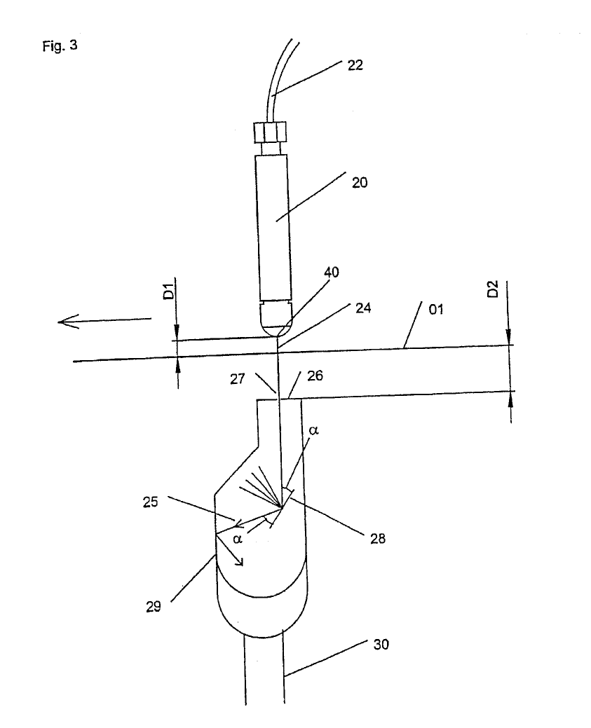

FIG. 3, the cutting device in FIG. 1 in an enlarged plan view,

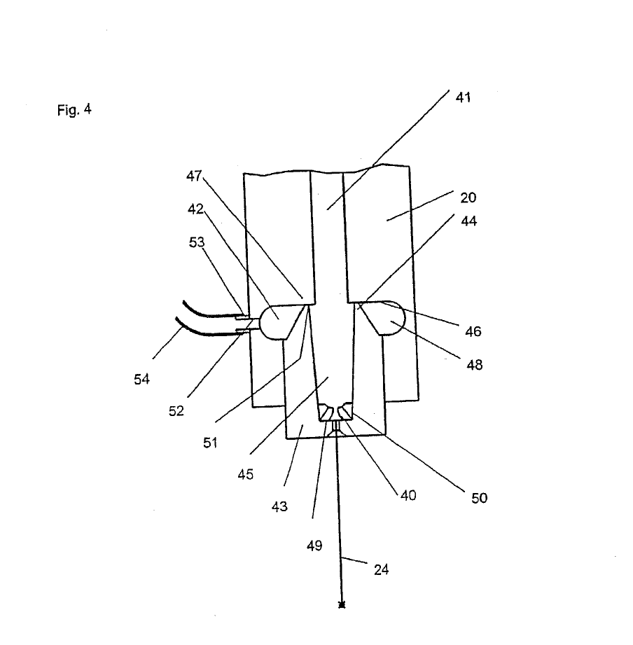

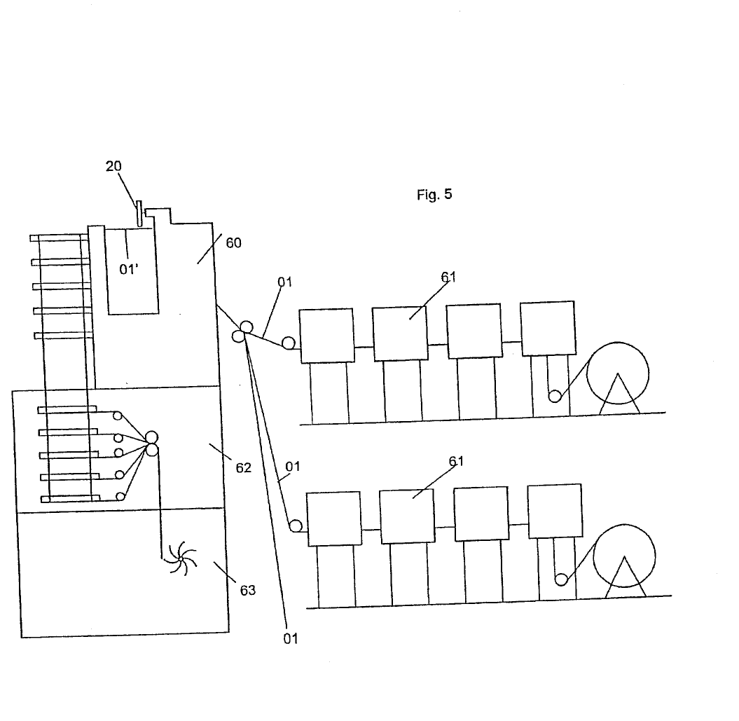

FIG. 4, an axial section of a nozzle which can be used with the device for cutting in accordance with the invention,

FIG. 5, an advantageous employment of the device in accordance with the invention.

FIG. 1 shows the device in accordance with the invention in a sectional view. The device is arranged above the superstructure of a folding apparatus and therefore is located at a height of a few meters above the floor of a structure in which the folding apparatus has been placed. It receives a paper web 01 from a web-fed rotary printing press, which has also been placed next to it on the floor of the structure. The web-fed rotary printing press, the superstructure and the folding apparatus can be of any known type, they are therefore not represented in the drawing figure and will not be described in detail.

The paper web 01 runs from a lower located printing press obliquely from below in the direction of the arrow 02 into the device for cutting. There, the paper web 01 is guided over a plurality of rollers 03, 04, 05, 06, each of which is maintained between two lateral walls of the device. One of these lateral walls 07 is represented in the drawing figure.

One of these rollers is an adjusting roller 04 with a displaceable shaft for compensating cutting differences in the paper web 01, moreover, a driven traction roller 05 for setting the web tension and finally a guide roller 06 are provided. From the guide roller 06, the paper web 01 is horizontally conducted transversely over an accessible gallery 08 to a guide roller 09. The gallery 08 makes access to the various rollers of the device available to operators for the purpose of performing maintenance work there, or to draw in a fresh paper web into the device. The water jet cutting device 10 is mounted on a horizontal section 11 of the paper web 01 between the guide rollers 06, 09. It divides the paper web 01 into a plurality of partial webs, which are fanned out behind the guide roller 09 and are conducted on guide rollers 12 and further on turning bars 13, from where the partial webs are fed, turned by 90°, down to the superstructure of the folding apparatus.

For the sake of simplicity of the representation, only five guide rollers 12 and turning bars 13 are each represented in the drawing figure; their number would for example be 13 in connection with an actual application, with a typical width of the paper web 01 on an order of magnitude of 3.60 m.

The water jet cutting device 10 includes a plurality of nozzle holders 20, which are supplied from a high-pressure pump, or a pressure transformer, not represented, with water at a pressure between 3500 and 4200 bar, typically 3800 bar, and support a jet, represented in detail in FIG. 4, for generating a high-pressure water jet. These nozzle holders 20 are on a support rod 21 extending over the entire width of the cutting device between the lateral wall 07.

FIG. 2 shows a view from above on a portion of the device in FIG. 1, in which the support rod 21 with four nozzle holders 20, mounted on it by means of clamps 23, can be clearly seen.

FIG. 3 shows the water jet cutting device in FIG. 1 in detail. The nozzle holder 20 is a cylindrical hollow body made of metal; a feed line 22 is screwed to its upper end, through which the nozzle holder 20 can be charged with high-pressure water from the pump. A nozzle 40 of an outlet diameter of 0.1 mm is located at the lower end of the nozzle holder 20, through which a high-pressure water jet 24 exits for cutting the paper web 01, which is conveyed in the direction of the arrow. The exit velocity of the jet 24 is determined by the pressure of the water upstream of the nozzle, at a charge of approximately 3800 bar an exit velocity of approximately 800 m/s results, which is more than half the speed of sound in water of 1500 m/s.

With the nozzle or jet diameter of 0.1 mm used here, the running time of a pressure or sound signal from one side of the jet 24 to the opposite side is approximately 0.67 μs. During this time, the jet 24 travels a distance of approximately 0.54 mm. Since the transition of the jet from the first into the second phase presupposes the interaction of various areas of the jet 24 with each other, which cannot be propagated in the jet 24 faster than the speed of sound, it is obvious that the transition into the second phase cannot take place before a sound signal has had time to move back and forth several times between opposite sides of the jet 24. In the course of each back and forth movement, the jet moves approximately 1 mm. Therefore, as represented in FIG. 3, for cutting a single layer paper web 01, a working distance D1 between the nozzle 40 and the paper web 01 is selected, which is traveled by the jet 24 during a length of time corresponding to five to six running times of the sound transversely to the jet direction, in the present case a distance of approximately 3 mm.

After the jet 24 has penetrated the paper web 01, it enters a collecting receptacle 25, whose top 26 extends at a distance D2 of approximately 10 mm from the paper web 01 transversely to the latter and which has a receiving opening 27 for this jet 24 opposite each nozzle 40. The collecting receptacle 25 constitutes a substantially closed chamber, with the exception of the receiving openings 27 and a drain opening 30, extending transversely to the running direction of the paper web 01. The diameter of the receiving opening 27 approximately corresponds to the distance D2 between the top 26 and the paper web 01, so that portions of the jet, paper dust and spray which were possibly laterally deflected in the course of the penetration of the paper web 01 are dependably caught in the receiving opening 27.

The jet 24 travels a distance of approximately 10 to 15 cm in the interior of the collecting receptacle 25 before impinging on a deflecting surface 28, for example in the form of a steel plate, whose normal surface extension forms an angle α of approximately 45° or more with the jet 24. The distance between the deflecting surface 28 and the jet 40 has been selected to be such that the jet 24, which has been slowed down on its way through the paper web 01 and the air, no longer performs any noticeable cutting effect. A second deflection surface 29 is a portion of the housing of the collecting receptacle 25. It is arranged in such a way that it is hit by a large portion of the jet water spread from the first deflecting surface 28.

The water flows off from the deflecting surfaces 28, 29 toward the bottom of the collecting receptacle 25, which is shaped in the form of a gutter inclined toward the drain opening 30. The water can flow off through the drain opening 30 by the action of gravity alone; however, it is possible to additionally connect a suction pump (not represented) to the drain opening in order to respectively aspirate water spray and/or paper dust out of the zone in which the jet 24 cuts the paper web 01 into the collecting receptacle 25, if required. Because of the high pulsation of the jet 24, such dust is generated, if at all, only at the side of the paper web 01 facing away from the jet 40, so that its aspiration on this side is entirely sufficient, and a second aspirating device on the side of the jet 40 can be omitted.

FIG. 4 shows an example of a possible design of the lower area of the nozzle holder 20 with the nozzle 40 shaping the jet 24. The nozzle holder 20 is a substantially cylindrical body of metal, for example stainless steel, with a centered longitudinal channel 41, which is connected to the feed line 22 at its upper end (not represented). On the lower end of the nozzle holder 20, the longitudinal channel 41 terminates in a cylindrical section 42, open toward the bottom and widened, whose inner wall has an interior screw thread. An insert 43, which has a lower cylindrical section and an upper section 44 in the shape of a truncated cone, has been screwed into this interior screw thread. A bore 45, which tapers toward the bottom, extends the longitudinal channel 41 into the insert 43.

The nozzle 40, a ring made of a hard alloy, rests on a shoulder 49 on the bottom of the tapering bore 45. It is fixed in place in this position by a seal ring 51, which is also pressed against the shoulder 49 by the water pressure prevailing in the bore 45, and in this way centers the nozzle 40. The nozzle 40 has a clear diameter of 0.1 mm. This diameter has been proven to be particularly suited for cutting paper since, on the one hand, the narrow diameter leads to a small water throughput through the nozzle 40 and therefore to a small danger of moistening the cut paper while, on the other hand, the momentum of the jet at the admission pressure used is still high enough for cleanly cutting the paper web 01, even at high web speeds.

The section 44 in the shape of a truncated cone terminates in a sharp edge 50, which in the course of screwing the insert 43 is pressed against the front face 46 of the widened section 42 in order to provide a seal, for example by cold welding, between the nozzle holder 20 and the insert 43. To make such a seal easier, or to improve it, a ring 47 of a soft metal, such as copper, can be inserted into the front face 46 in the area of the edge 50 as indicated in FIG. 4 by dashed lines.

In case the seal between the insert 43 and the nozzle holder 20 is not perfect, an annular hollow chamber 48, which extends all around the section 44 in the shape of a truncated cone, has been provided in the nozzle holder 20, and receives water penetrating between the edge 50 and the upper interior surface. The hollow chamber 48 is connected via a radial bore 52, through which the water can escape, with the surroundings. Since in no case is this water allowed to drip on the paper web 01 to be cut, the bore 52 is extended on the outside by means of a connector 53, on which a hose 54 for carrying off the water has been pushed. Since the water in the hollow chamber 48 is essentially at atmospheric pressure, no particular demands are being made on the pressure resistance of the hose 54 and its fastening to the connector 53. A simple hose clamp, for example, is entirely sufficient for fixing the hose 54 in place.

FIG. 5 schematically represents a further development of the device in accordance with the invention, which here has been provided with the reference symbol 60 as a whole. Here, paper webs 01 from several printing presses 61 which, in accordance with the invention are placed on top of each other, i.e. a multilayered paper web 01′ built up from several individual webs, are cut by the device at the inlet of the device 60. Multilayered partial webs are obtained in this way at the outlet of the device, and the number of partial webs which must be brought together in the superstructure 62 of the folding apparatus 63 in order to put together a brochure of a predetermined number of pages, for example, is reduced. It is also conceivable to convey the cut multilayered partial webs to the folding apparatus 63 without the interposition of a superstructure.

For cutting the multilayered paper web 01′ it is useful that the jet 24 is in the second phase, therefore the distance between the nozzle 40 and the paper web 01′ is selected to be greater than indicated above in relation to FIG. 3, it can be up to ten times the sonic running time transversely to the jet direction.

List of Reference Symbols

| | |
|---|---|
| 01 | Paper web |
| 02 | Arrow |
| 03 | Roller |
| 04 | Adjusting roller |
| 05 | Traction roller |
| 06 | Guide roller |
| 07 | Lateral wall |
| 08 | Gallery |
| 09 | Guide roller |
| 10 | Water jet cutting device |
| 11 | Horizontal section |
| 12 | Guide roller |
| 13 | Turning bar |
| 14 to 19 | — |
| 20 | Nozzle holder |
| 21 | Support rod |
| 22 | Feed line |
| 23 | Clamp |
| 24 | Jet, high-pressure water jet |
| 25 | Collecting receptacle |
| 26 | Top |
| 27 | Receiving opening |
| 28 | Deflecting surface |
| 29 | Deflecting surface |
| 30 | Drain opening |
| 31 to 39 | — |
| 40 | Nozzle |
| 41 | Longitudinal channel |
| 42 | Widened section |
| 43 | Insert |
| 44 | Section |
| 45 | Bore |
| 46 | Front face |
| 47 | Ring |
| 48 | Hollow chamber |
| 49 | Shoulder |
| 50 | Edge |
| 51 | Seal ring |
| 52 | Bore |
| 53 | Connector |
| 54 | Hose |
| 55 to 59 | — |
| 60 | Device for cutting |
| 61 | Printing press |
| 62 | Superstructure |
| 63 | Folding apparatus |
| D1 | Working distance (40, 01) |
| D2 | Distance (01, 25, 26) |
| α | Angle |
| c | Speed of sound in water |
| d | Jet diameter |
| v | Jet velocity |
| D1 | Distance jet to paper web |

1. A device for cutting paper webs (01) into several partial webs, wherein the device is arranged in a web-fed rotary printing press between a printing unit and the inlet of the folding apparatus for folding the cut partial webs, characterized in that it comprises a water jet cutting device (10).

2. A device for cutting paper webs by means of a water jet cutting device (10), characterized in that the distance (D1) from the nozzle (40) to the paper web (01) corresponds to three to ten times the sonic running time transversely in relation to the diameter of the jet (24) generated by the nozzle (40).

3. A device for cutting paper webs by means of a water jet cutting device (10), characterized in that the water jet cutting device (10) can be charged with water pressure at more than 3500 bar, in particular between 3500 and 4200 bar.

4. A device for cutting paper webs by means of a water jet cutting device (10), characterized in that the paper web (01) is conducted at a distance (D1) of 2 to 5 mm from the nozzle (40).

5. The device in accordance with claims 1, 2, 3 or 4, characterized in that the water jet cutting device has a nozzle (40) with a clear diameter of 0.1 mm.

6. The device in accordance with claims 1, 2 or 3, characterized in that the paper web (01) is conducted at a distance of 2 to 5 mm from the nozzle (40).

7. The device in accordance with claims 1, 2, 3 or 4, characterized in that the speed of the paper web (01) is 14 to 18 m/s.

8. The device in accordance with claims 1, 2 or 4, characterized in that the water jet cutting device (10) can be charged with water pressure at more than 3500 bar, in particular between 3500 and 4200 bar.

9. The device in accordance with claims 1, 3 or 4, characterized in that the distance (D1) from the nozzle (40) to the paper web (01) corresponds to three to ten times the sonic running time transversely in relation to the diameter of the jet (24) generated by the nozzle (40).

10. The device in accordance with one of the preceding claims, characterized in that a collecting receptacle (25) is arranged at a distance of 5 to 15 mm from the paper web (01).

11. The device in accordance with one of the preceding claims, characterized in that the collecting receptacle (25) has at least one deflecting surface (28) for slowing the jet (24), which is arranged obliquely in respect to the jet direction.

12. The device in accordance with one of claims 10 or 11, characterized in that the water jet cutting device (10) has a plurality of nozzles (40), which are arranged in a row, and that the collecting receptacle (25) extends along the row in order to collect the jets (24) from all nozzles (40).

13. The device in accordance with one of claims 10 to 12, characterized in that the collecting receptacle can be charged with underpressure.

14. The device in accordance with one of the preceding claims, characterized in that several paper webs are arranged on top of each other.

15. The device in accordance with claims 1, 2, 3 or 4, characterized in that the paper web (01) is imprinted.
